(19) United States
(12) Patent Application Publication
(10) Pub. No.: US 2022/0032177 A1
(43) Pub. Date: Feb. 3, 2022

(54) GAME CONTROLLER HAVING GRIPS WHOSE ANGLES AND ORIENTATIONS CAN BE ADJUSTED

(71) Applicant: Mehmet Tunc TURGUT, Istanbul (TR)

(72) Inventor: Mehmet Tunc TURGUT, Istanbul (TR)

(21) Appl. No.: 17/299,351

(22) PCT Filed: Dec. 7, 2019
(86) PCT No.: PCT/TR2019/051041

§ 371 Date: Jun. 3, 2021

(30) Foreign Application Priority Data
Dec. 7, 2018 (TR) 2018/18830

(51) Int. Cl. A63F 13/24

(52) U.S. Cl. CPC A63F 13/24

(57) ABSTRACT

A game controller is provided. The game controller includes a primary grip and a secondary grip, wherein angles and orientations of the primary grip and the secondary grip are adjusted to provide different usage angles for a user when a game is being played. The game controller allows the angles and orientations of the primary grip and the secondary grip to be adjusted via at least a motion element located within a configuration of the motion element.

### CROSS REFERENCE TO THE RELATED APPLICATIONS

This application is the national stage entry of International Application No. PCT/TR2019/051041, filed on Dec. 7, 2019, which is based upon and claims priority to Turkish Patent Application No. 2018/18830 filed on Dec. 7, 2018, the entire contents of which are incorporated herein by reference.

### TECHNICAL FIELD

The invention is related to a game controller having grips whose angles and orientations can be adjusted in order to provide different usage angles for the user when a game is being played.

### BACKGROUND

Nowadays as digital games are becoming more and more prevalent in public, the importance of accessories that are used for such games have also increased.

In the recent years e-sports competitions have increased and this has led users to spend long periods of time, sitting in front of game consoles, computers and similar gaming machines. If the users use unsuitable game accessories, this may lead to health problems in the future.

On the other hand as e-sports are played based on momentary reflexes, the maximum compatibility of the accessory used to the body of the user, shall also increase the performance of the user.

One of the most important gaming accessories used by players/users during the game is the game controllers which enable to transfer the commands of the user to the gaming machine. The controllers which are generally configured to fit the palm of the user, are held by both hands. The user usually operates a group of command units by using one hand and another group of command units by using the other hand. For example while the user is operating the movement orientation buttons with one hand the other hand may have access to command buttons.

In order for the hands of the user to be able to able to completely grip the controller, left and right grips have been provided. The user can grip the right and left grips by his/her hands and can operate the primary grip and the secondary grip.

However as the grips on the game controller is provided to have the same size, angle and orientation for all kinds of players having different ages and sizes, it brings about usage problems. Such usage problems may become very uncomfortable for players who need to play without giving a break for long periods of time, such as playing e-sport competitions.

The limited structures of the game controllers, may also lead to other health problems for users. As the users operate the controller with their fingers and hands being fixed at a certain angle for long periods of time and with contraction, the player may have health issues with his hands and arms.

The patent application numbered US2017368452 can be given as an example to game controllers used in the prior art. The game controller subject to the application, comprises a left grip for the left hand of the user and a right grip for the right hand of the user. The mid section between the grips have further been equipped with several command buttons.

The embodiment subject to the patent numbered US2017368452 has been equipped with an adjustable thumbtack in order to increase user ergonomics. As the hardness of the thumbtack can be adjustable, the user can adjust the usage conditions that may have different hardness, and therefore can operate the grip according to his her own preference.

The patent application numbered U.S. Pat. No. 6,743,100, discloses a game controller having user pivotal grips for adjusting the size. Keeping in mind that the users all may have different sized hands, the length of the hand grips can be adjusted via the handles. The handles are connected to the hand grips of the game controller at a pivot point. This situation allows the handles to be able to be rotated, however it does not allow the whole hand grip to be turned. Due to this reason the user uses the handles in order to change the size of the hand grips, but the handles cannot be used to adjust the hand grips to be adjusted to different angles and orientation.

Although the patent numbered U.S. Pat. No. 6,743,100 allows the adjustment of game controllers according to hand sizes, as it does not allow the adjustment of the angles and orientation of the hand grips, the invention is particularly far from meeting the professional user preferences, and remedying the user sensitivities that is formed during usage. The muscle and joint problems that may arise due to prolonged usage cannot be solved by the invention subject to the application numbered U.S. Pat. No. 6,743,100.

### SUMMARY

The aim of the invention is to provide a game controller having grips which can be adjusted in different angles and orientations.

The adjustability of the angles and orientation of the grips allows different usages by different players and allows to improve product ergonomics.

In e-sports competitions and similar organizations where the players need to use the game controller for prolonged period of times, the players shall be able to change the angles and orientation of the grips during the game. By this means the discomfort that has arised due to keeping the game controller at the same position for a long period of time shall be able to be eliminated.

As keeping the game controller at the same position by the players for a long period of time can lead to different disorders, changing of the angles and orientation of said grips by the player may prevent such problems from arising.

The players place their arms and fingers on the controller at a contracted position during a game. This situation leads to pressure increase on the arm, hands and fingers and increases the possibility of experiencing health problems. However by being able to change the angles and orientation of the grips by the player during a game, the pressure on the arms and fingers shall be reduced and thereby the risk of experiencing health problems shall also be decreased.

By using the embodiment subject to the invention it shall be possible to ensure that game controllers are professionalized. Different users having different usage habits shall be able to use the game controller in different ways. By this means the performance of the players when playing digital games which mostly require momentary reflexes shall also increase.

### BRIEF DESCRIPTION OF THE DRAWINGS

FIG. 1: Top view of the game controller having grips which can be adjusted in different angles and orientations.

FIG. 2: Rear view of the game controller equipped with a spherical motion element, having grips which can be adjusted in different angles and orientations.

FIG. 3: Top view of the game controller having grips whose angles and orientations have been changed.

FIG. 4: Top view of the game controller which allows the angle and orientation of the grips to be adjusted by rotating the primary grip body relative to the secondary grip body.

FIG. 5: Top view of the game controller which allows the angle and orientation of the grips to be adjusted by means of the motion element located between the primary grip body relative to the secondary grip body.

### DESCRIPTION OF THE REFERENCES IN THE FIGS.

1. Primary grip
1.1 Primary gripping body

2. Secondary grip
2.1 Secondary gripping body

3. Motion element

### DETAILED DESCRIPTION OF THE EMBODIMENTS

The invention is related to a game controller which allows the angle and orientation of the grips (1,2) to be adjusted via motion element(s) (3) located within its configuration.

As it is known, game controllers include a primary grip (1) and a secondary grip (2) that have been formed on the right and left side of the controller in order for the user to be able to completely grip his/her hands.

The player can grip the primary grip (1) and the secondary grip (2) and can operate the primary and secondary group command units.

In order for the primary grip (1) and the secondary grip (2) to be able to arrange at different angles and orientations, the primary grip (1) and the secondary grip (2) have been connected to at least a motion element (3). By this means in order for the hands of the user to be used comfortably, the user is able to easily adjust the orientations and angles of the primary grip (1) and the secondary grip (2) via the motion element.

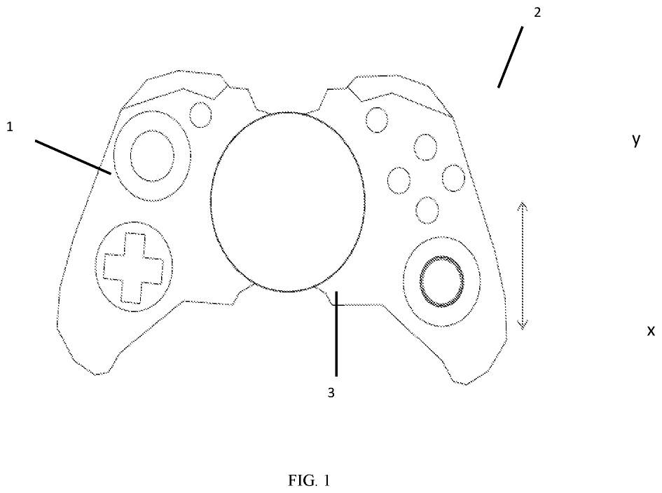

According to FIG. 1, a motion element (3) has been provided between the primary grip (1) and the secondary grip (2). According to this embodiment the motion element (3) has been disposed in the mid section between the primary grip (1) and the secondary grip (2).

The embodiment according to FIG. 1, illustrates a configuration having a circular motion element (3) provided between the primary grip (1) and the secondary grip (2). The grips (1,2) are able to be rotated around the motion element (3) axially by taking the motion element (3) as the centre. By this means the user can turn both the grips (1,2) together or independent from each other on both the x and y axis and can change the angle and orientations of the grips.

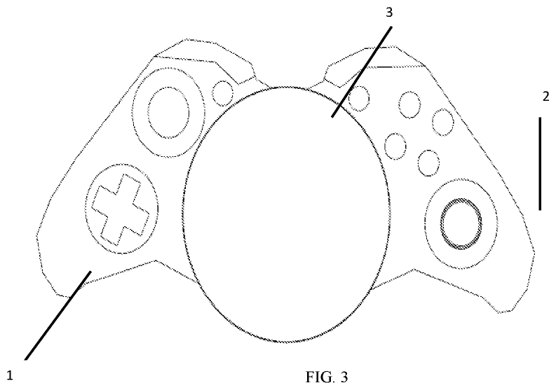

FIG. 3, shows the situation where both the primary grip (1) and the secondary grip (3) are turned towards the y orientation at the motion element (3) axis.

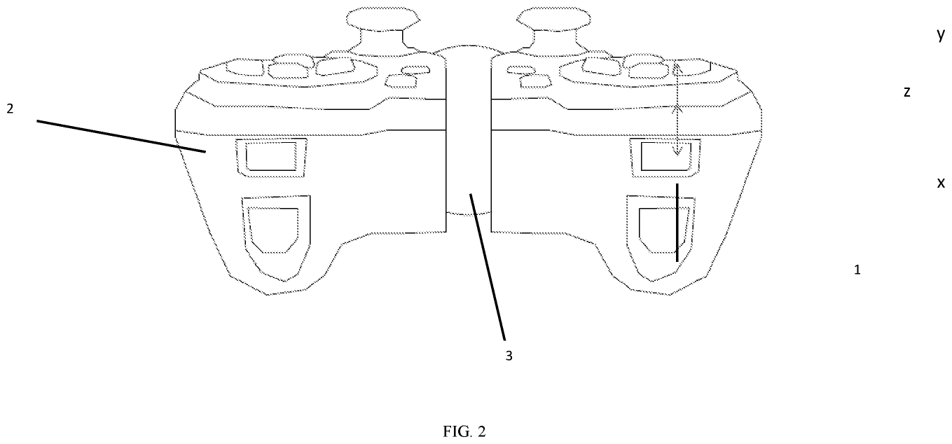

According to the embodiment illustrated in FIG. 2, a spherical motion element (3) has been provided between the primary grip (1) and the secondary grip (2). The motion element (3) that has been designed as a spherical structure, allows the grips (1,2) to be moved along the z axis, besides the x and y axis and at the motion element (3) centre.

Usages of different motion elements (3) to enable the adjustment of the angles and orientations of the primary grip (1) and the secondary grip (2) are also within the scope of the invention.

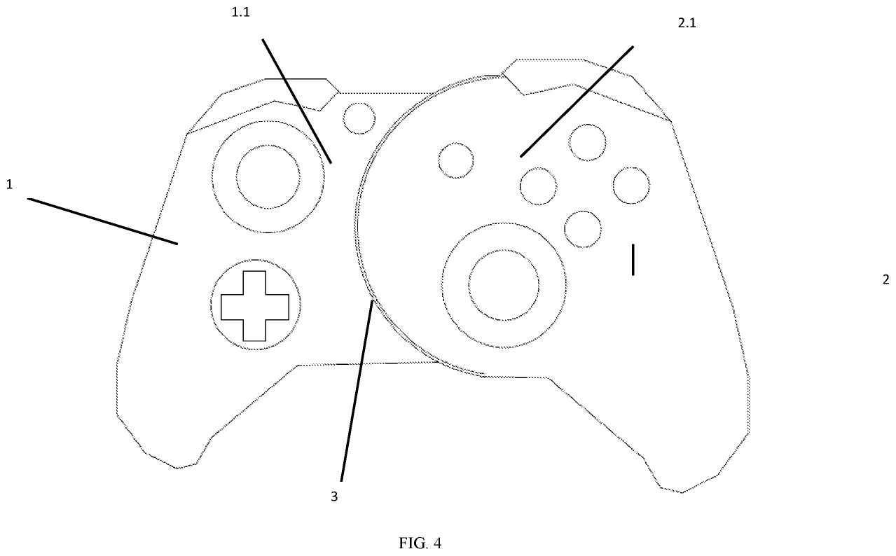

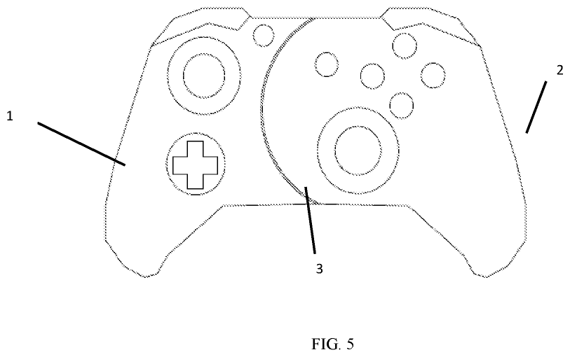

The motion element (3) structures illustrated in FIGS. 4 and 5 can be given as examples to said usages.

Rotating of the primary grip body (1.1) relative to the secondary grip body (2.1) shall be sufficient in order for the angles and orientations of the primary grip (1) and the secondary grip (2) to be adjusted. In such a case the motion element (3) can define an apparatus or configuration which enables the primary grip body (1.1) to be rotated relative to the secondary grip body (2.1).

The embodiment of FIG. 4, has been associated with the wider secondary grip body (2.1) rather than the primary grip body (1.1) and as a result a game controller application which allows the primary grip body (1.1) to be rotated relative to the secondary grip body (2.1) is disclosed.

Again in FIG. 5, the primary grip body (1.1) and the secondary grip body (2.1) have been equipped with a motion element (3) configuration which allows them to be moved at the same dimension, axially relative to each other. Thereby the adjustment of the angles and orientations of the primary grip (1) and the secondary grip (2) can be performed.

A motorized equipment can be used in order to adjust via the motion element (3) the angles and orientations of the primary grip (1) and the secondary grip (2) and also the independent or collective axial movements of the grips (1,2) can be carried out via user drive.

According to an alternative embodiment of the invention the motion element (3) has been equipped with a fixing element. The fixing element fixes the adjusted positions after the user has adjusted the angle and orientations of the primary grip (1) and the secondary grip (2). Thereby the involuntary motion of the angles and orientations of the primary grip (1) and the secondary grip (2) during usage, shall be prevented.

What is claimed is:

1. A game controller, comprising a primary grip and a secondary grip, wherein the primary grip and the secondary grip are arranged on a right side and a left side of the game controller; the primary grip and the secondary grip are configured to be grips by hands of a user; the game controller at least comprises motion element in order configured to adjust angles and orientations of the primary grip and the secondary grip.

2. The game controller according to claim 1, wherein the motion element is located between the primary grip and the secondary grip.

3. The game controller according to claim 2 claim 2, wherein the motion element is located at a mid-section between the primary grip and the secondary grip.

4. The game controller according to claim 1, wherein the primary grip and the secondary grip include comprise the motion element having a configuration, wherein the configuration of the motion element allows the primary grip and the secondary grip to be moved axially by taking the motion element as a centre.

5. The game controller according to claim 4, wherein the motion element is a circular shaped motion element.

6. The game controller according to claim 4, wherein the motion element is a spherical shaped motion element.

7. The game controller according to claim 4, wherein the motion element defines an apparatus or configuration and the apparatus or configuration enables a primary grip body to be rotated relative to a secondary grip body.

8. The game controller according to claim 7, wherein the secondary grip body is designed to be wider than the primary grip body.

9. The game controller according to claim 7, wherein a size of the primary grip body is identical to a size of the secondary grip body.

10. The game controller according to claim 1, wherein a motorized equipment is provided to adjust the angles and orientations of the primary grip and the secondary grip via the motion element.

11. The game controller according to claim 1, wherein the motion element has a configuration allowing an independent and collective movement of the primary grip and the secondary grip via a user drive.

12. The game controller according to claim 1, comprising a fixing element, wherein the fixing element fixes adjusted positions after the user has adjusted the angles and orientations of the primary grip and the secondary grip.
